(19) United States
(12) Patent Application Publication
(10) Pub. No.: US 2008/0104075 A1
(43) Pub. Date: May 1, 2008

(54) Distribution list navigator

(76) Inventor: Roland Heumesser, Rottenburg (DE)

Correspondence Address: Robert Popa, Esq.;c/o LADAS & PARRY, Suite 2100, 5670 Wilshire Boulevard, Los Angeles, CA, 90036-5679, US

(21) Appl. No.: 11/586,430

(22) Filed: Oct. 25, 2006

(51) Int. Cl. G06F 17/30

(52) U.S. Cl. 707/7; 707/E17.002

(57) ABSTRACT

A method is provided of automatically generating and updating e-mail distribution lists including e-mail addresses of persons of an organization. The method uses an arrangement of the persons in one or more groups according to an organizational relationship. The one or more groups are stored in an organizational database system. An e-mail distribution list structure reflecting the arrangement of the persons in the one or more groups according to the organizational relationship is generated by automatically merging the e-mail addresses of the persons of the one or more groups into corresponding e-mail distribution lists. The e-mail distribution lists are updated consistently with an update of the organizational database system.

### FIELD OF THE INVENTION

The present invention generally relates to the management of electronic mail distribution lists, and for example, to methods, computer systems, computer program products and propagated signals for automatically generating and updating e-mail distribution lists based on an arrangement of persons in groups stored in an organizational database system.

### BACKGROUND OF THE INVENTION

With the advent of the information age, writing electronic mails (e-mails) has become common practice, so that nowadays the number of e-mails sent per day by far exceeds the number of paper letters. In the course of this development, a negative aspect of this easy and fast way of sending information has also become apparent, namely the fact that many Internet users are inundated with worthless information. According to a general impression, numerous participants in the electronic mail service receive information more than fifty percent of which falls into the category “spam”. Spam is electronic junk mail which is sent to a great number of recipients via e-mail and is mostly advertising with commercial background.

Spam, however, is a minor problem (which may be kept under control by technical measures, such as filters) in comparison to the change of communication behavior of participants in the electronic mail communication system. Electronic mail services provide the convenient possibility to address not only a specific person but also a group of persons belonging to a so-called distribution (mailing) list. In a company, for instance, distribution lists are useful since they enable the sender to address a whole department or workgroup by means of a mnemonic e-mail address instead of writing an e-mail to each individual employee, which would imply a memorization of the e-mail address of each employee. Nevertheless, a couple of problems arise almost inevitably when using mailing lists. People get a lot of e-mails via mailing lists because the sender selects the wrong mailing list, or the recipient of the e-mail is not interested in the topic of the mailing list anymore since s/he—in the case of a company—has changed the department or left the company, but has forgotten to unsubscribe from a mailing list or has not been taken off a mailing list. In professional life, people tend to use distribution lists extensively and thereby may divulge even confidential information to people the information is not intended for, but as the person has not been removed from the distribution list, s/he still gets the information by mistake. Accidentally, it might even happen that an employee who has changed company but is still on several distribution lists may receive information which might be useful for his/her new company. For this reason, every organization using distribution lists has to think about ways of solving problems associated with them.

It would be understandable to assume that information disclosed via spam e-mails or information disclosed via obsolete e-mail distribution lists would be disregarded in the same way a user who normally does not want to be bothered by either of these. The substantial difference, however, is that spam is never confidential and may be discarded by means of filters, whereas information from e-mail distribution lists may be confidential and cannot be filtered. Therefore, a need-oriented supply with information is, generally speaking, one of the major challenges the Internet is facing today. To tackle this information-logistic problem within an organization, easy-to-see distribution list management systems with e-mail addresses arranged in structures and mailing lists displayed as icons have been developed. These management systems enable the user to browse through a structure of e-mail distribution lists, and select the e-mail distribution list containing the desired recipients. However, these lists have to be continually updated which has been performed manually till now.

Document JP 11275135 discloses a system of simultaneous distribution of electronic mail, in which a transmitter prepares a hierarchy table which defines how an e-mail is distributed in a hierarchy, and sends the hierarchy table together with the e-mail to the recipients. However, there is no possibility to access information concerning an arrangement of persons in groups from a human resource database and update the recipients of the e-mails accordingly.

Document JP 07183910 A describes, in order to display the management of addresses in an easy-to-see state and to send a mail speedily and accurately, that the addresses are displayed as icons and are arranged in a hierarchical structure in the display. Data are stored in an external storage device, and are read in by a control means.

### SUMMARY OF THE INVENTION

The invention is directed to a method of automatically generating and updating e-mail distribution lists including e-mail addresses of persons of an organization. The method uses an arrangement of the persons in one or more groups according to an organizational relationship. The one or more groups are stored in an organizational database system. An e-mail distribution list structure reflecting the arrangement of the persons in the one or more groups according to the organizational relationship is generated by automatically merging the e-mail addresses of the persons of the one or more groups into corresponding e-mail distribution lists. The e-mail distribution lists are updated consistently with an update of the organizational database system.

According to another aspect, a computer system is provided for automatically generating and updating e-mail distribution lists including e-mail addresses of persons of an organization using an arrangement of the persons in one or more groups according to an organizational relationship. The one or more groups are stored in an organizational database system. The computer system is programmed to generate an e-mail distribution list structure reflecting the arrangement of the persons in the one or more groups according to the organizational relationship by automatically merging the e-mail addresses of the persons of the one or more groups into corresponding e-mail distribution lists, and to update the e-mail distribution lists consistently with an update of the organizational database system.

According to yet another aspect, a computer program product is provided which is either in the form of a machine-readable medium with program code stored on it, or in the form of a propagated signal including a representation of program code. The program code is arranged to carry out a method, when executed on a computer system, of automatically generating and updating e-mail distribution lists including e-mail addresses of persons of an organization using an arrangement of the persons in one or more groups according to an organizational relationship. The one or more groups are stored in an organizational database system, the program code is programmed to generate an e-mail distribution list structure reflecting the arrangement of the persons in the one or more groups according to the organizational relationship by automatically merging the e-mail addresses of the persons of the one or more groups into corresponding e-mail distribution lists, and to update the e-mail distribution lists consistently with an update of the organizational database system.

Other features are inherent in the methods and products disclosed or will become apparent to those skilled in the art from the following detailed description of embodiments and its accompanying drawings.

### BRIEF DESCRIPTION OF THE DRAWINGS

Embodiments of the invention will now be described, by way of example, and with reference to the accompanying drawings, in which:

FIG. 1 shows a high-level architecture diagram of a system providing a distribution list navigator, according to embodiments of the invention;

FIG. 2a shows a graphical user interface displaying an arrangement of persons in groups of a university which is induced by grouping the persons according to a workgroup relationship as ticked in a menu, according to embodiments of the invention;

FIG. 2b shows a graphical user interface displaying an arrangement of persons in groups of a university which is induced by grouping the persons according to a disciplinarian relationship as ticked in the menu, according to embodiments of the invention;

FIG. 2c shows a graphical user interface displaying an arrangement of persons in groups of a university which is induced by grouping the persons according to a department relationship as ticked in the menu, according to embodiments of the invention;

FIG. 2d shows a graphical user interface displaying an arrangement of persons in groups of a university which is induced by grouping the persons according to a chair relationship as ticked in the menu, according to embodiments of the invention;

FIG. 3a shows a table of a relational database scheme in which the workgroup relationship of a university is modeled, according to embodiments of the invention;

FIG. 3b shows an XML-tree structure which corresponds to the workgroup relationship of FIG. 3a, according to embodiments of the invention;

FIG. 4a shows a table of a relational database scheme in which the disciplinarian relationship of a university is modeled, according to embodiments of the invention;

FIG. 4b shows an XML-tree structure which corresponds to the disciplinarian relationship of FIG. 4a, according to embodiments of the invention;

FIG. 5a shows a table of a relational database scheme in which the department relationship of a university is modeled, according to embodiments of the invention;

FIG. 5b shows an XML-tree structure which corresponds to the department relationship of FIG. 5a, according to embodiments of the invention;

FIG. 6a shows a table of a relational database scheme in which the chair relationship of a university is modeled, according to embodiments of the invention;

FIG. 6b shows an XML-tree structure which corresponds to the chair relationship of FIG. 6a, according to embodiments of the invention;

FIG. 7 shows a configuration file defining distribution lists corresponding to the relationships modeled in the relational database scheme, according to embodiments of the invention;

FIG. 8a shows an updating procedure on demand, in response to a selection of a criterion, whereby the XML-trees of all criteria are used, according to embodiments of the invention;

FIG. 8b shows an updating procedure on demand, in response to a selection of a criterion, whereby only the XML-tree of the selected criterion is used, according to embodiments of the invention;

FIG. 8c illustrates an incremental updating procedure on demand, in response to a selection of a criterion, whereby the changes of the XML-trees of all criteria are used, according to embodiments of the invention;

FIG. 8d illustrates an incremental updating procedure on demand, in response to a selection of a criterion, whereby the changes of the XML-tree of the selected criterion are used, according to embodiments of the invention;

FIG. 8e shows a time-controlled updating procedure, performed at regular intervals, whereby the XML-trees of all criteria are used, according to embodiments of the invention;

FIG. 8f shows an incremental, time-controlled updating procedure, performed at regular intervals, whereby the changes of the XML-tree of the selected criterion are used, according to embodiments of the invention;

FIG. 8g shows an updating procedure triggered by a change in the organizational database system, whereby the XML-trees of all criteria are used;

FIG. 8h shows an updating procedure triggered by a change in the organizational database system, whereby the changes of all XML-trees of all criteria are used;

FIG. 9a shows a table indicating person-dependent access rights to distribution lists in accordance with their position in a hierarchy, according to embodiments of the invention;

FIG. 9b shows a graphical user interface from the point of view of a person having restricted access rights, according to embodiments of the invention; and

FIG. 10 is a diagrammatic representation of an embodiment of a mail server computer system, according to embodiments of the invention.

The drawings and the description are of the embodiments of the invention and not of the invention itself.

### DESCRIPTION OF THE PREFERRED EMBODIMENTS

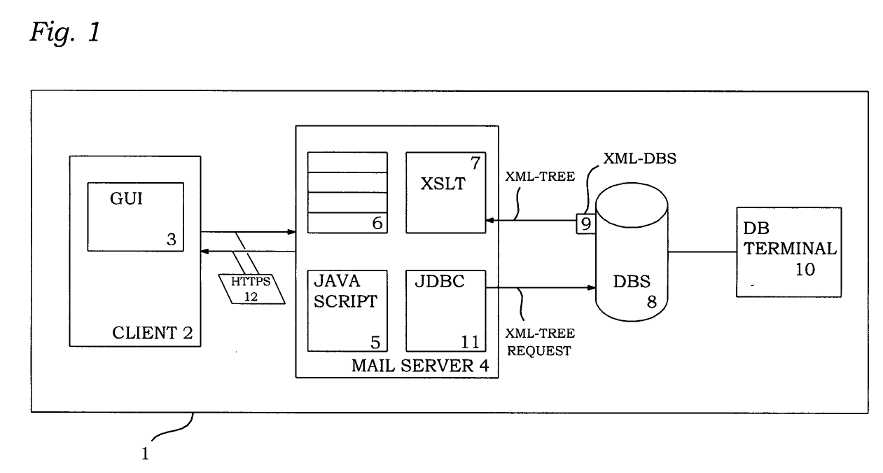

FIG. 1 shows a high-level architecture diagram of a preferred embodiment of a system for the management of distribution lists. However, before proceeding further with the description of FIG. 1, a few items of the embodiments will be discussed.

In some of the embodiments, e-mail distribution list including e-mail addresses of persons of an organization are automatically generated and updated using an arrangement of the persons in one or more groups according to an organizational relationship. The one or more groups are stored in an organizational database system. An e-mail distribution list structure reflecting the arrangement of the persons in the one or more groups according to the organizational relationship is generated by automatically merging the e-mail addresses of the persons of the one or more groups into corresponding e-mail distribution lists. The e-mail distribution lists are updated consistently with an update of the organizational database system.

The expression “organizational relationship” refers to a relationship reflecting a structure of an organization. The relationship may, for example, model the relationships among persons (for example, a disciplinarian relationship), the relationship between persons and projects (for example, a workgroup relationship) or the relationship between persons and the organization itself (for example, a department relationship).

The term “organizational database system” refers to a database system, as used, for example, in a human resource department, which stores relationships concerning the relationships of persons among each other, relationships between persons of an organization and projects, or relationships between persons and the organization. In some of the embodiments, the database system is for example an SQL-based database system of a human resource department, whereas in other embodiments the database system is a directory server accessible via LDAP (lightweight directory access protocol, see for example RFC 4511). The lightweight directory access protocol is a network protocol that permits request and modification of information of a directory service (implemented as a distributed database system). LDAP is a network protocol running on the application layer (TCP/IP protocol stack) which is used in the context of directory services. It connects the communication between the so-called LDAP-client (e.g. a mail server, a mail client, e.g. “Thunderbird”, or a digital address book like in the outlook client) and the directory (directory server) from which person-related data is read. LDAP is not only a network protocol but also defines the data structure of an LDAP directory. Many providers of directory services support LDAP such as “Novell Directory Services” and “Microsoft Active Directory Services”.

The wording “arrangement of the persons in one or more groups according to an organizational relationship” refers to a grouping of persons according to an organizational relationship (criterion). There are different criteria conceivable according to which the persons may be grouped, and each grouping results in another arrangement. Alternatively, one could also say that by grouping the persons according to different criteria, different views onto the same persons are induced.

In some of the embodiments, an arrangement of the persons of an organization in groups is a hierarchy, which means that the groups are ordered according to a subgroup relationship which forbids a person to belong to two or more groups which are not in a subgroup-relationship. For example, according to the relationship “workgroup”, it is possible that one person may belong to two workgroups, whereby the members of the one workgroup are not all included in the other workgroup which contradicts the idea of a hierarchy. Another view of the persons, such as a grouping according to a disciplinarian relationship, typically—but not necessarily—induces a hierarchy since a person only has one direct disciplinarian.

In many organizations using e-mail communication appliances, it is observable that the structure of distribution lists by means of which users may address a group of people within the organization coincides with the arrangement of persons in groups. This observation leads to the following consideration:

In many organizations, e-mail distribution lists are organized and displayed in analogy to the arrangement of persons in groups(s) of the organization. Since the users are mostly familiar with such an arrangement of persons in groups, it is easy for them to identify the right e-mail distribution list containing the e-mail addresses of the persons they want to address. Furthermore, this prevents additional network traffic and effort caused by wrongly selected distribution lists.

Moreover, human resource departments of organizations possess organizational database systems mostly anyway in which all the relevant information about people such as name, department, workgroup, disciplinarian, e-mail address, etc. is stored. In general, this human resource database is always up-to-date, and is typically updated manually by an employee of the human resource department.

Thanks to these parallel structures of e-mail distribution lists and the arrangement of persons in groups stored in a human resource database, a distribution list navigator is coupled to an organizational database system, such as a human resource database system. A mapping can be performed from information stored in the human resource database onto the structure of e-mail distribution lists. By means of this mapping, the effort of maintaining e-mail distribution lists is reduced since any updates in entries of the database system are automatically tracked in the e-mail distribution lists. The e-mail distribution lists may endue a nested structure, which means that an e-mail distribution list itself may contain a list of e-mail distribution lists. These nested e-mail distribution lists are normally illustrated as a tree structure when presented to a user. The person-related data in the organizational database system may be stored according to a relational data model.

E-mail distribution lists are basically aliases (mnemonic addresses by means of which a user addresses a group of people stored in a distribution list) which are stored, in some of the embodiments, in a configuration file on a mail server and to which individual e-mail addresses are assigned. A user accesses the mail server via a web interface running on a client. An organizational database system which stores the arrangement of persons in groups and the mail server communicate via a tree structure represented in a data exchange format. This means that the tree in a data exchange format is made from the data stored in the organizational database system and reflects the relationships of the persons stored in the organizational database system. The tree is transmitted to the mail server where the e-mail addresses are extracted out of the tree, and are inserted into the corresponding distribution lists in the configuration file on the mail server.

In some of the embodiments, the e-mail addresses defining the e-mail distribution lists are stored in a configuration file on the mail server. The configuration file is divided into different sections storing a set of e-mail distribution lists for each criterion.

In other embodiments, one tree structure includes information for defining the e-mail distribution list of one criterion.

In some of the embodiments, updating the e-mail distribution lists includes generating at least one tree structure or parts thereof out of the data stored in the organizational database system by a middleware component. Then, the arrangement of persons in groups or parts thereof is/are transmitted to the mail server where the corresponding e-mail distribution lists in the configuration file are updated.

In other embodiments, a graphical user interface displays the groups in a tree-like manner by means of icons, and offers possibilities to hide and re-display selected sub-structures of e-mail distribution lists.

In some of the embodiments, the user is provided with an option to choose a criterion among a predetermined set of criteria. These criteria define in which way the persons are grouped and presented to the user. These criteria may be a disciplinarian relationship, workgroup affiliation relationship or department affiliation relationship. If a user selects disciplinarian relationship as a criterion, then the persons of the organization will be grouped according to their position in the organizational hierarchy. Subsequently, if the user selects workgroup affiliation as a criterion, the same persons who had previously been grouped according to their disciplinarian are then grouped according to their workgroup affiliation. By selecting criteria, different views of the persons are induced, and thereby different person groups and arrangement of persons in groups come into being. This selection of a criterion is useful since a grouping according to several criteria cannot be displayed simultaneously in one overview without confusing the user. Each person group corresponds to one distribution list, whereby the e-mail addresses of the persons are merged into corresponding e-mail distribution lists. The groups are displayed in a graphical user interface by means of icons. The user may select a distribution list to which s/he wishes to address an e-mail. As members quit the organization or new employees join the organization, the distribution lists are updated continuously so that the e-mails always reach the designated recipients.

The updating of the distribution lists may be performed in different ways:

1. Update in response to selecting a criterion:

a) In some of the embodiments, the e-mail distribution lists are updated whenever a user selects a criterion. This selection entails that tree structures in a data exchange format are generated containing e-mail addresses in a structured way. There is a tree structure for every criterion which represents the structure of the e-mail addresses according to the selected criterion. The tree structures are transmitted to the mail server featuring a configuration file where the distribution lists are defined. The e-mail addresses are extracted from each tree structure, and are used to newly build the corresponding distribution lists. The updated distribution lists are displayed in a tree-like manner in a graphical user interface where the user may select the distribution list to which s/he wishes to address an e-mail. By clicking on a distribution list, the address of the list is added to a recipient field of an application program for composing and sending e-mails.

b) In other embodiments, the updating is also performed in response to a user selecting a criterion. In this case, however, not all tree structures are newly generated out of the current data from the organizational database system, but only that tree structure belonging to the criterion selected by the user. This tree structure is transmitted to the mail server, and the distribution lists of the user-selected criterion are newly built based on the information contained in the tree structure. The distribution lists which do not belong to the selected criterion are not updated and may therefore contain obsolete data.

c) In yet another embodiment, the updating is also performed in response to a user selecting a criterion. In this case, however, not the complete tree structures are generated and transmitted, but only partial tree structures which are affected by changes in the entries of the organizational database system are generated and transmitted. The information stored in the partial tree structures is used to update the distribution lists of all criteria. In contrast to the two previously presented updating modes, the distribution lists are not built anew, but only changes are made. Therefore, this way of updating is also referred to as an incremental procedure.

d) In yet another embodiment, the updating is also done incrementally, in response to a user selecting a criterion. Unlike the previous updating mode, only the partial trees representing changes in the tree structure of the user-selected criterion are transmitted to the mail server. As in the last updating mode, the distribution lists are not built from new, but only changes are made.

2. Update at regular intervals:

a) In other embodiments, the distribution lists are not updated in response to a user selecting a criterion, but the updating occurs periodically at regular intervals. Every time, after a predetermined period of time has expired, the tree structures of all criteria are generated from new out of the current data from the organizational database system and are transmitted to the mail server. The distribution lists are newly created on the basis of information contained in the tree structure.

b) In yet another embodiment, the distribution lists are updated periodically at regular intervals and incrementally in such a way that partial trees of tree structures of all criteria are generated and transmitted to the mail server. The distribution lists of all criteria are corrected on the basis of information of the partial trees. The time-controlled updating mechanism does not guarantee that the distribution lists presented to the user are consistent with the data stored in the organizational database system since a user may be added to the organizational database system but is not added to the distribution lists and displayed in the graphical user interface immediately since the update does not occur until a later point of time.

3. Update in response to a change in the database system:

a) In some of the embodiments, the update is triggered by a change in the entries of the database system. If the database system storing the persons' data is updated, then all tree structures are generated anew and are transmitted to the mail server. The distribution lists are newly created on the basis of information contained in the tree structures.

b) In another embodiment, the update is also triggered by a change in the database system. In this case, only partial trees are generated representing the changes in the database system. These partial trees are transmitted to the mail server and are used to update the distribution list. This update procedure is called “incremental”. The updating procedures triggered by a change in the database system guarantee that the database system and the distribution lists are consistent.

The system is further endowed with a graphical user interface, in which the user is presented with the distribution lists arranged in a reasonable way. Normally, the distribution lists are arranged in a tree-like form, and the user is enabled to browse through this structure by clicking on icons which represent an e-mail distribution list, and which may be further divided into sub e-mail distribution lists represented as sub-trees. In some of the embodiments, the user is not only presented with e-mail distribution lists, but also with individual users s/he may address. In the case of a hierarchy representing who is disciplinarian of whom in an organization, the persons on the lowest level are only represented as individual e-mail addresses, whereas a person on a higher level is represented as both an individual e-mail address, but also as an e-mail distribution list containing the e-mail addresses of all employees hierarchically beneath said person and the person him-/herself.

In some of the embodiments, the user is also shown the number of recipients of each distribution list. The number of users is displayed in the graphical user interface in proximity to the icon of the corresponding distribution list. Thereby, the user is informed whether s/he addresses only a few or a large number of persons. A large number of recipients indicated may urge the user to re-think whether it is really necessary to address an e-mail to all of them and/or to review the content of the e-mail carefully. This feature improves the information management within the organization and reduces the number of undesired e-mails.

In some of the embodiments, the system is provided with a feature restricting the users' access to distribution lists. More specifically, the access to distribution lists may be restricted according to a user's position within the arrangement of persons in groups which means that persons are not allowed to select distribution lists containing people who occupy higher positions than themselves.

In some of the embodiments, this access restriction is implemented by presenting the user only with a limited set of distribution lists according to her/his position within the arrangement of persons in groups.

In some of the embodiments, a server sends a request to the organizational database system concerning an e-mail distribution list, and receives a representation in an exchangeable message format.

In some of the embodiments, the exchangeable message format is XML.

In other embodiments, the persons and the e-mail distribution lists are displayed in the graphical user interface, and can be addressed by means of an e-mail application program.

Some of the embodiments of the computer program product with program code for performing the described methods include any machine-readable medium that is capable of storing or encoding the program code. The term “machine-readable medium” shall accordingly be taken to include, for example, solid state memories and, removable and non removable, optical and magnetic storage media. In other embodiments, the computer program product is in the form of a propagated signal including a representation of the program code, which is increasingly becoming the usual way to distribute software. The signal is, for example, carried on an electromagnetic wave, e.g. transmitted over a copper cable or through the air, or a light wave transmitted through an optical fiber. The program code may be machine code or another code which can be converted into machine code, such as source code in a multi-purpose programming language, e.g. C, C++, Java, C#, etc. The embodiments of a computer system may be commercially available general-purpose computers programmed with the program code.

Returning now to FIG. 1, which shows an e-mail distribution list navigator 1 as a distributed system implemented within a non-public computer network (intranet). The distributed system is a client-server system in which a user interacts with a browser running on a computer system (client 2) in which the user views a structure of e-mail distribution lists in a graphical user interface 3. A user chooses a criterion in the graphical user interface 3 according to which s/he wishes persons of an organization to be grouped. This grouping of the persons is displayed in the graphical user interface 3. Every person group corresponds to exactly one distribution list. This structure is visualized by means of icons in the form of an HTML (Hypertext Markup Language)-document. The user selects the desired distribution list by actuating a hyperlink and the client 2 communicates via HTTPS (Hypertext Transfer Protocol Secure) 12 with a mail server 4 having a configuration file 6 in which the e-mail distribution lists are defined by assigning e-mail addresses to e-mail distribution lists which are referenced by aliases (mnemonic e-mail addresses). An e-mail distribution list is therefore basically an alias to which all individual e-mail addresses belonging to the distribution list are assigned. A Java script 5 runs on the mail server 4 which controls the generation and updating of the e-mail distribution lists. The Java script 5 sends a request to the database system 8 and asks for information by means of which the e-mail distribution lists in the configuration file 6 are generated or updated. The information requested by the Java script 5 is transmitted in a data exchange format to the mail server 4. In the given embodiment, the data exchange format between the database system 8 and the mail server 4 is XML. XML stands for Extensible Markup Language, and is a standard used for exchanging messages between different applications (see, for example: http://www.w3.org/tr/rec-xml). After the mail server 4 has received the XML-tree which contains e-mail addresses in a structured way, the e-mail addresses are extracted, and are used to update the corresponding distribution lists stored in configuration file 6. The configuration file 6 is divided into several sections since there are different criteria according to which the user may group the persons, and each grouping is associated with an XML-tree. Each XML-tree, in turn, contains information for a set of e-mail distribution lists. Therefore, there are as many sections in the configuration file 6 as there are user-selectable criteria. Each section of the configuration file 6 stores the definitions of e-mail distribution lists associated with one criterion. The organizational database system 8 is further coupled to a database terminal 10 which enables a user, e.g. a person from the human resource department, to update entries in the organizational database system 8. As will be explained below, a manual update of entries of the organizational database system 8 via the database terminal 10 may result in XML-trees being transmitted to the mail server 4 and an update of the e-mail distribution lists. Alternatively, as mentioned above, the database system 8 may also be an LDAP-server storing a directory with person-related data which is accessible via LDAP.

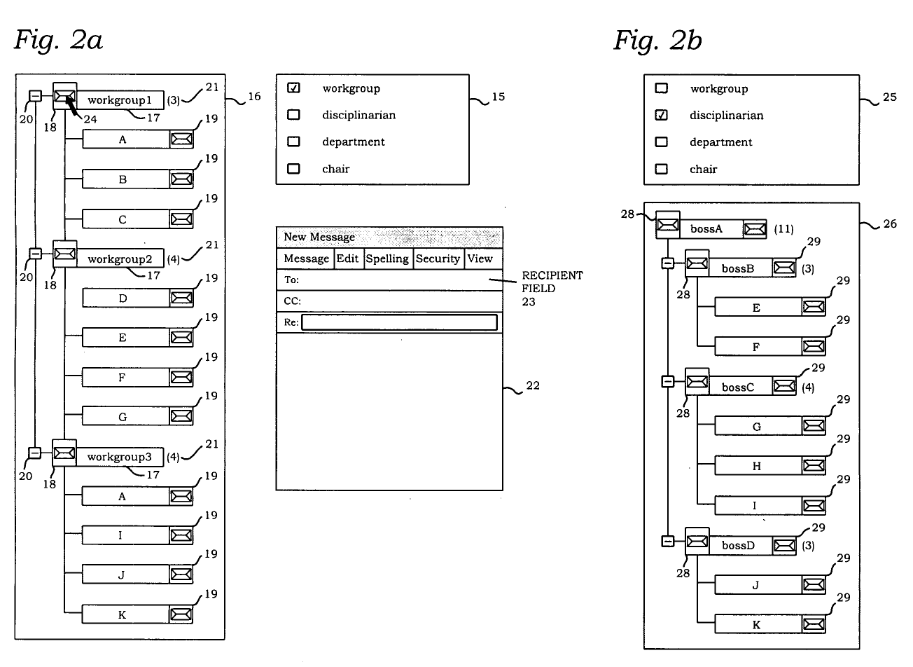

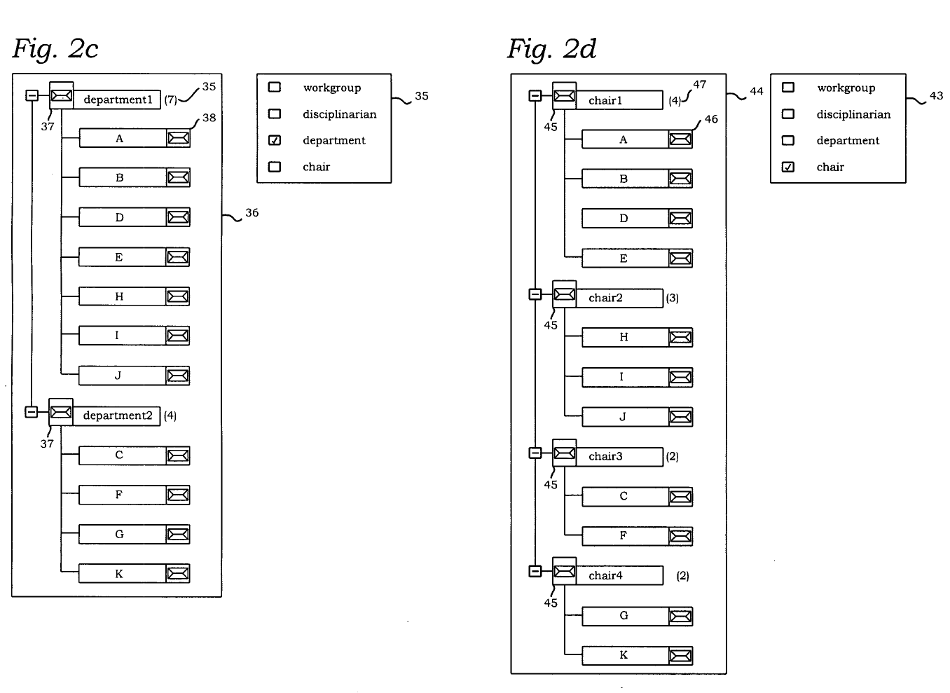

FIG. 2a shows a selection menu 15 with four icons shown in the graphical user interface 3 in which a user has ticked “workgroup” as the criterion according to which s/he wishes the personnel of a university to be grouped and displayed in the graphical user interface 3 of the e-mail distribution list navigator 1. After that, an arrangement of persons in groups induced by this selection is shown in display 16. Display 16 shows a clipping of a grouping of personnel of a university according to a “workgroup” criterion as displayed to the user in the graphical user interface 3. There are three workgroups provided, whereby workgroup1 contains three persons (number of persons is indicated in parentheses) may be addressed via an e-mail distribution list icon 18. The individual persons A, B and C are assigned to this workgroup, and may be addressed via the icons 19 displayed right behind the persons. Workgroup2 may also be addressed by an e-mail distribution list icon 18, and includes the persons D, E, F, G who may also be individually addressed via icons 19 right behind their names. Workgroup3 includes four persons A, I, J and K who are addressable via icons 19 right behind their names. It should be mentioned that person A is member of workgroup1 and workgroup3. Therefore, the arrangement of persons in groups induced by the workgroup criterion is not a hierarchy. If a user clicks on any of the e-mail icons 18, 19, an e-mail application for composing e-mails 22 pops up and the address of the selected distribution list (workgroup1@university.edu) is added to a recipient field 23 of an e-mail application 22 for composing e-mails. It should be mentioned that in the display 16, there are also icons 20 “−” provided indicating that the sub-structure is currently shown. If a user clicks onto a “−”, the sub-structure is hidden and the “−” turns into a “+” icon.

FIG. 2b shows a different grouping of the same university personnel of FIG. 2a according to the disciplinarian relationship ticked by the user in the menu 25. The diagram illustrates who is disciplinarian of whom. To the left of the name of some of the persons, there is an e-mail icon 28 by means of which one may address the persons hierarchically beneath the person including the person itself via an e-mail distribution list. It should be mentioned that the e-mail distribution lists are named according to the respective disciplinarian, i.e. “boss”. In order to address the respective boss only, one may click on the icon on the right of the name of each boss. The e-mail icon to the right of the person's name is an icon 29 by means of which one may address the individual person only. The number of persons hierarchically beneath a person is indicated in parentheses to the right of each name. Person C, for instance, is in this depiction disciplinarian of three persons, namely persons G, H, and I. The grouping of persons according to a disciplinarian relationship induces a hierarchy, contrary to the workgroup relationship illustrated in FIG. 2a.

FIG. 2c shows yet another grouping of the university personnel. A user has selected “department” as a criterion according to which s/he wishes the personnel to be grouped. Similar to the two previous groupings, a user may select e-mail distribution list “department1”, which includes all members of department1, by clicking on icon 37. In the example, the persons are disjointedly grouped either into e-mail distribution list “department1” or into “department2”. However, it is also conceivable that a person may be assigned to both e-mail distribution lists since s/he is a member of both departments. By clicking on icon 37 or 38, an e-mail application program 22 pops up, and the e-mail distribution list is added to the recipient field 23.

FIG. 2d shows a grouping of the personnel according to the chair relationship. A user has selected “chair” as a criterion according to which s/he wishes the personnel of the university to be grouped. The resulting grouping is shown in display 44.

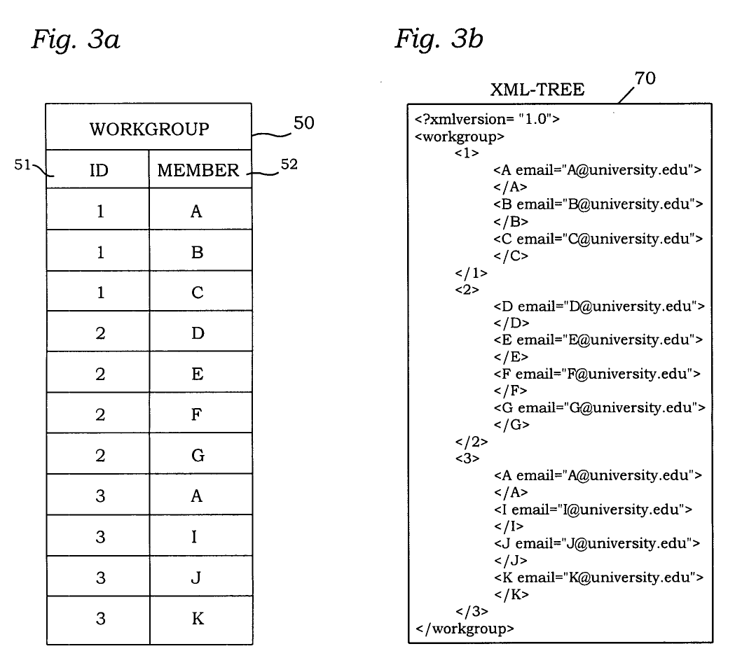

FIG. 3a shows a table 50 of a relational database scheme which is stored in the organizational database system 8. The table 50 represents the workgroup relationship of persons, symbolized as capital letters A to K, of a university. The table 50 stores the information which is displayed in the graphical user interface 3, as shown in FIG. 2a.

FIG. 3b illustrates in which form the information stored in table 50 is transmitted to the mail server 4. First, the information is transformed into a tree-structure of a data exchange format. The most common data exchange format currently used is XML, and therefore lends itself to being used for representing data stored in a organizational database system 8 in a standardized way. Software packages like XML-DBS transform instantiations of relational database schemes into XML documents. XML-DBS is available as a set of Java packages. Java is used in context with organizational database systems via JDBC. JDBC technology is an API (included in both J2SE and J2EE releases) that provides cross-DBS connectivity to a range of SQL databases and access to other tabular data sources, such as spreadsheets.

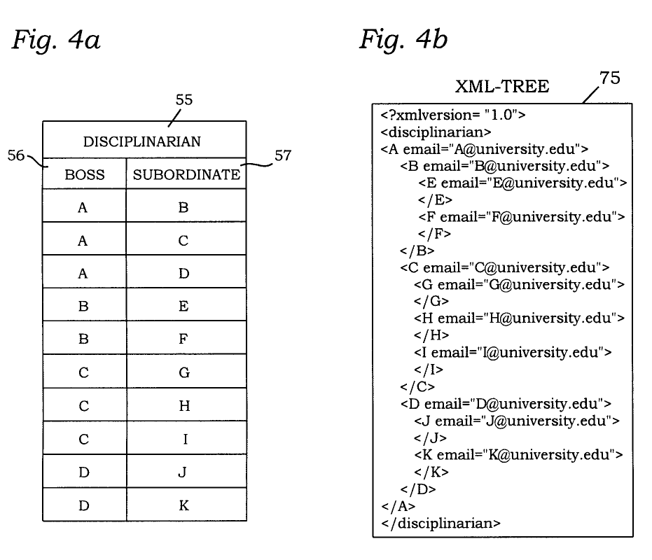

FIG. 4a shows a table of a relational database scheme in which a disciplinarian relationship 55 (criterion) is depicted. The left column refers to attribute “boss” 56, whereas the right column refers to attribute “subordinate” 57. A boss usually has several subordinates, e.g. boss A has the subordinates B, C, and D.

FIG. 4b depicts an XML-tree 75 which corresponds to the disciplinarian relationship, and shows how the database table is transformed into a tree structure of a data exchange format, such as XML. In XML, a tree structure is obtained by means of opening angle brackets (< >) and correspondingly closing angle brackets (</>).

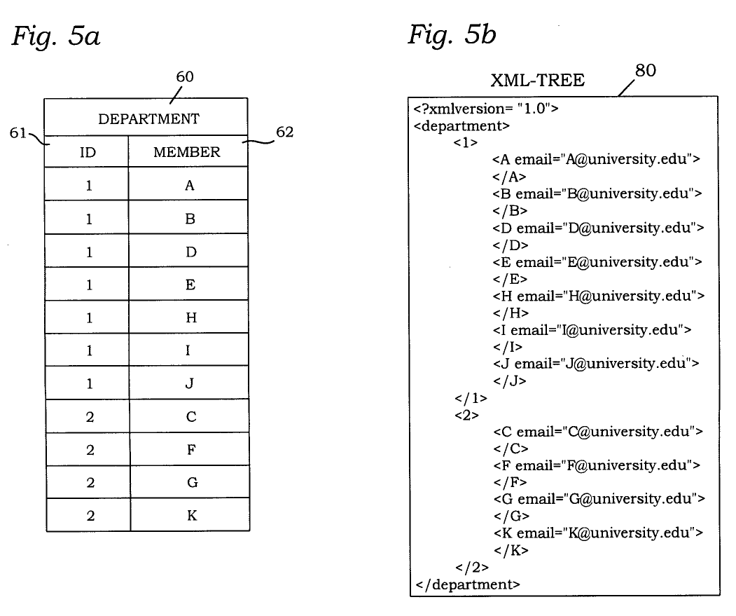

FIG. 5a shows a table of a relational database scheme in which a department relationship 60 is depicted. The left column 61 refers to attribute “id”, whereas the right column 62 refers to attribute “member”.

FIG. 5b shows an XML-tree 80 representing the data stored in the relational database table of FIG. 5a.

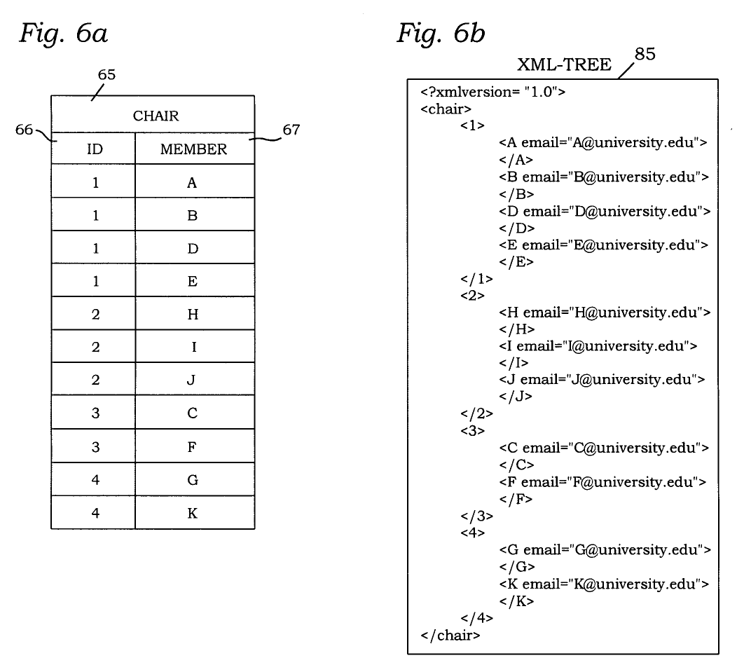

FIG. 6a shows a table indicating a (university) chair relationship 65. The left column 66 indicates different ids, and the right column 67 says which persons belong to which chair.

FIG. 6b shows an XML-tree 85 representing the data stored in the relational database table of FIG. 6a.

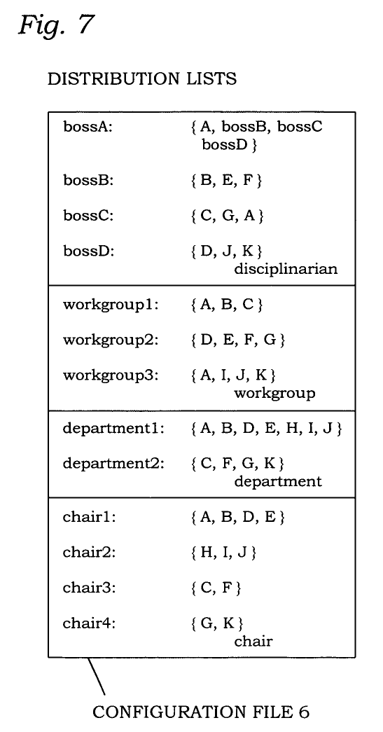

FIG. 7 shows the configuration file 6 on the mail server 4 in which the different distribution lists are defined. When the system is initialized, the distribution lists are newly defined in the configuration file 6. That means that the e-mail addresses are extracted from each of the XML-trees 70, 75, 80, 85 and inserted into the corresponding distribution lists. The extraction of information stored in XML documents is done by XSLT, which is a programming language allowing the extraction of information from XML documents, and/or by the transformation of one XML-document (source-tree) into another. A transformation expressed in XSLT describes rules for transforming a given source-tree into a result-tree. The transformation is achieved by associating patterns with templates. A pattern is matched against elements in the source-tree, and a template is instantiated to create parts of the result-tree. The result-tree is separate from the source-tree. The structure of the result-tree can be completely different from that of the source-tree. In constructing the result-tree, elements from the source-tree can be filtered and reordered, and arbitrary structure can be added. Since the result-tree is still in XML format, control characters such as tags are removed to assign the e-mail addresses to distribution lists. The distribution lists are aliases to which e-mail addresses are assigned. If one wishes to address the persons of the university organization who have person B as disciplinarian, then s/he may use the e-mail address “groupB@university.edu”, whereby “groupB” is considered as the alias defined in the configuration file 6. By convention, person B is also member of this distribution list. The configuration file 6 is also divided according to the criteria, among which the user may choose the grouping of the persons of the organization. Each criterion has its own different set of distribution lists.

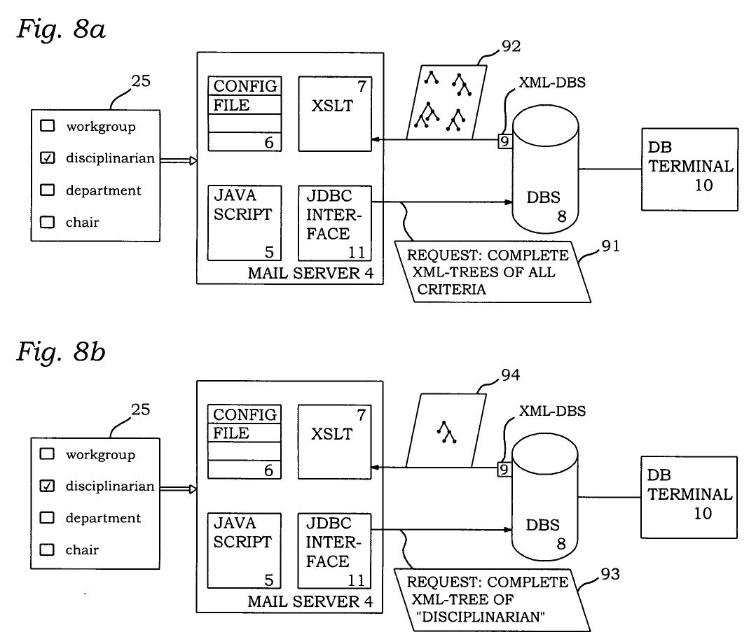

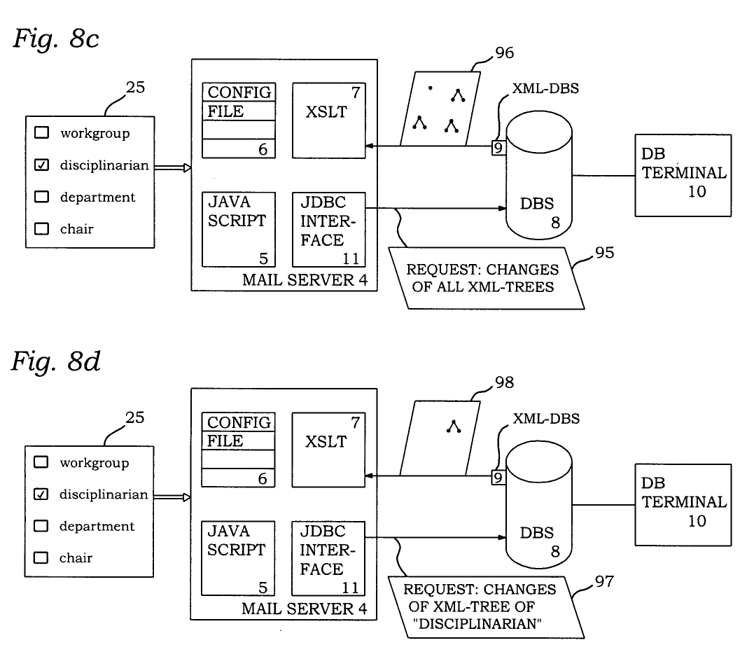

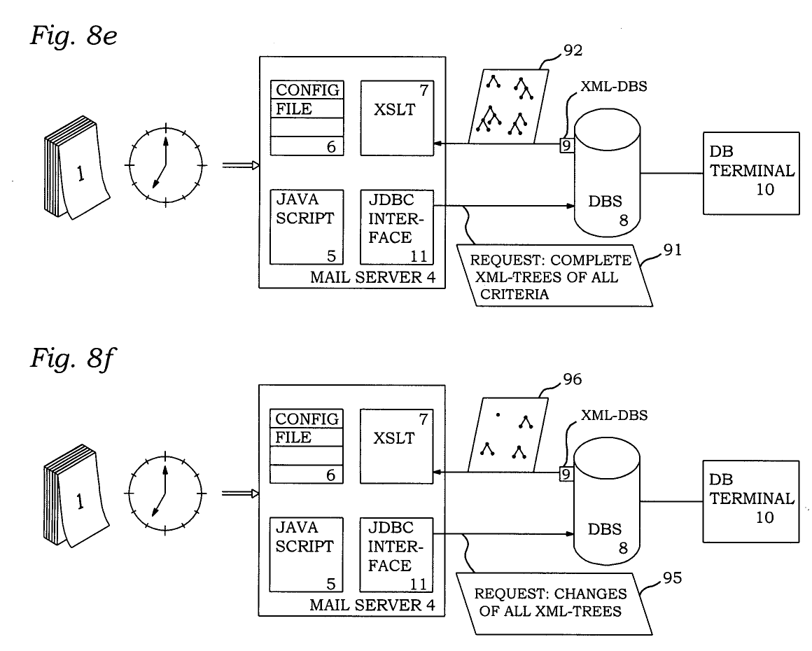

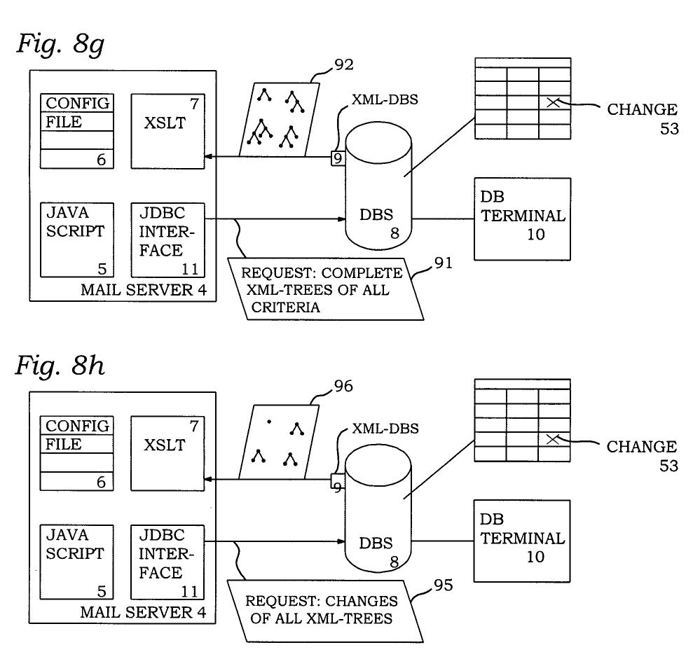

In FIGS. 8a to h, different modes of updating e-mail distributions lists are discussed:

FIG. 8a shows an updating of distribution lists on demand. “On demand” means that the update only occurs when the user employs the distribution list navigator 1. Before the user is presented with the distribution lists, s/he is shown in the graphical user interface 3 the menu 25 with four selection icons by means of which s/he may choose the criterion according to which s/he wishes the personnel to be grouped. This selection causes the script 5 on the mail server 4 to send a request 91 that the complete XML-trees of all criteria 92 are newly generated from the current data from the organizational database system 8 and are transmitted to the mail server 4, where the distribution lists defined in the configuration file 6 are updated accordingly. Then, the personnel structure induced by the user-selected criterion is displayed in the graphical user interface 3. This updating procedure guarantees that the distribution lists are always in consistency with the organizational database system 8, and that the user is presented with a current representation of the structure of distribution lists according to the chosen criterion.

FIG. 8b also depicts an updating procedure on demand, but in this case, the selection of a criterion only entails that the script 5 on the mail server 4 sends a request 93 that the complete XML-tree of the selected criterion “disciplinarian” 93 is generated out of the current data from the organizational database system 8. The XML-tree is transmitted to the mail server 4, where the distribution lists defined in the configuration file 6 are updated accordingly. Then, the personnel structure induced by the user-selected criterion is displayed in the graphical user interface 3. This updating procedure guarantees that the distribution lists belonging to the selected criterion are consistent with the organizational database system 8 and are displayed in the current version. At this stage, distribution lists associated with other criteria may not be up-to-date, but these could only be selected by the user when s/he clicks on another criterion in the menu 25, which would entail an updating of the distribution lists associated with the latter criterion.

FIG. 8c shows an updating procedure on demand, which is performed incrementally. If a user selects a criterion, it is determined in the organizational database system 8 whether a change in the entries of the organizational database system 8 has occurred. If a change has occurred, then the script 5 on the mail server 4 causes a request 95 to be sent that not the complete XML-trees, as shown in FIG. 8a should be transmitted, but only partial XML-trees 96 of all XML-trees in which changes have occurred should be transmitted to the mail server 4. In this case, all changes concerning any distribution lists are represented as partial XML-trees 96 and all distribution lists (not only those belonging to/associated with the selected criterion) are updated. Then, the personnel structure induced by the user-selected criterion is displayed in the graphical user interface 3. This updating procedure guarantees that the distribution lists are always in agreement with the organizational database system 8, and that the user is presented with a current representation of the structure of distribution lists according to the chosen criterion.

FIG. 8d depicts an updating procedure on demand, which is performed incrementally. If a user selects a criterion, it is determined in the organizational database system 8 whether a change in the entries of the organizational database system 8 has occurred. If a change has occurred, then the script 5 on the mail server 4 causes a request 97 to be sent to the organizational database system 8 that only the partial XML-trees affected by changes of the selected criterion 98 be transmitted to the mail server 4. The partial XML-trees 98 are transmitted to the mail server 4, where the distribution lists defined in the configuration file 6 are updated accordingly. Then, the personnel structure induced by the user-selected criterion is displayed in the graphical user interface 3. This updating procedure guarantees that the distribution lists associated with the selected criterion are consistent with the organizational database system 8, and are displayed correctly. At this stage, distribution lists, however, associated with other criteria may not be up-to-date, but these could only be selected by the user when s/he clicks on another criterion in the menu 25, which would entail an updating of the distribution lists associated with the latter criterion.

FIG. 8e shows a time-controlled updating of the distribution lists. At regular intervals, in this case every second day, the script 5 running on the mail server 4 sends the request 91 to the organizational database system 8 that the complete XML-trees of all criteria 92 be transmitted from the organizational database system 8 to the mail server 4. The organizational database system 8 sends XML-trees of all criteria to the mail server 4. The distribution lists defined in the configuration file 6 are then updated according to the new data from the organizational database system 8. This updating mode, however, does not guarantee that the distribution lists are always consistent with the organizational database system 8, as there may be a delay between the update of the organizational database system 8 and the update of the distribution lists.

FIG. 8f also shows a time-controlled updating of the distribution lists, which is performed incrementally. At regular intervals, in this case every second day, the script 5 running on the mail server 4 sends a request 95 that all partial XML-trees of all criteria representing changes 96 in the organizational database system 8 be transmitted to the mail server 4. The distribution lists defined in the configuration file 6 are then updated according to the new data from the organizational database system 8. This updating mode, however, does not guarantee that the distribution lists are always in agreement with the organizational database system 8, as there may be a delay between the update of the organizational database system 8 and the update of the distribution lists.

FIG. 8g shows an update procedure of the distribution lists, where the update is triggered by a change 53 in the organizational database system 8. Every time a change 53 (e.g. an update, deletion or insertion of an entry) in the organizational database system 8 occurs, the script 5 on the mail server 4 sends the request 91 to the organizational database system 8 so that complete XML-trees of all criteria 92 are newly generated and are transmitted to the mail server 4. The distribution lists in the configuration file 6 are then updated based on the XML-trees 92. This updating procedure guarantees that the distribution lists are always consistent with the data stored in the organizational database system 8, and that the data are always correctly displayed in the graphical user interface 3 of the distribution list navigator 1.

FIG. 8h shows an incremental update procedure of the distribution lists, where the update is triggered by a change 53 in the organizational database system 8. Every time a change 53 in the organizational database system 8 occurs, the script 5 on the mail server 4 sends a request 95 that partial XML-trees 96 representing the changes of distribution lists of all criteria be newly generated and are transmitted to the mail server 4. The distribution lists in the configuration file 6 are then updated on the basis of the partial XML-trees 96. This updating procedure guarantees that the distribution lists are always consistent with the data stored in the organizational database system 8 and that the data are always correctly displayed in the graphical user interface 3 of the distribution list navigator.

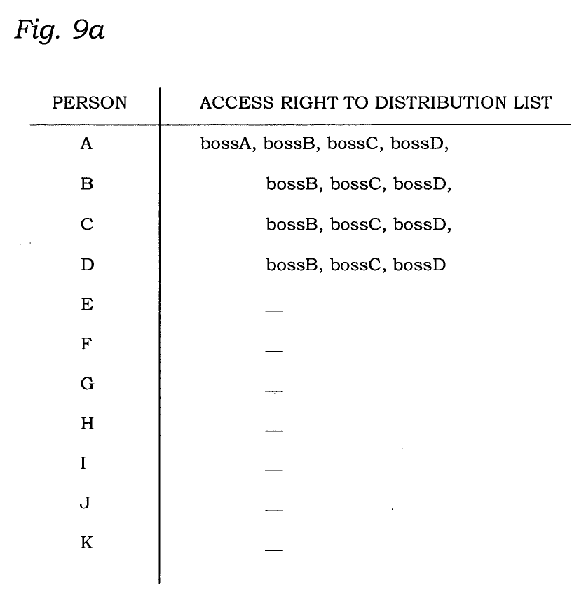

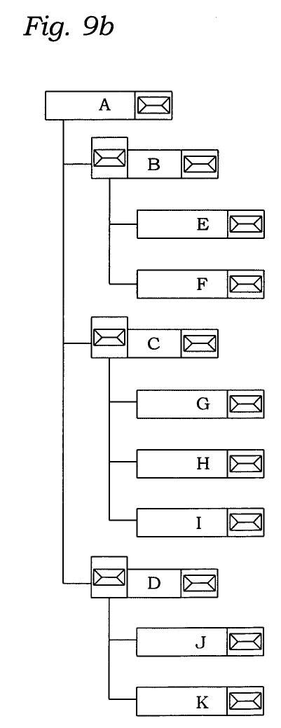

FIG. 9a refers to the disciplinarian hierarchy tree shown in FIG. 4b. The users are restricted in their access to distribution lists by an access policy saying that no person is allowed to select a distribution list containing persons that are hierarchically above said person. For example, person J on the lowest level is not allowed to access distribution list “bossB@university.edu” because it contains person B who is on a higher level.

FIG. 9b shows a graphical user interface as displayed to person D. The icons provided only refer to e-mail addresses of individual persons but not to e-mail distribution lists. Person D is not allowed to access the e-mail distribution list “bossA” (see FIG. 7) containing the e-mail address of person A and the e-mail distribution lists “bossB”, “bossC” and “bossD”. Therefore, there is no icon provided (in the view of person D) by means of which person D could access the e-mail distribution list A.

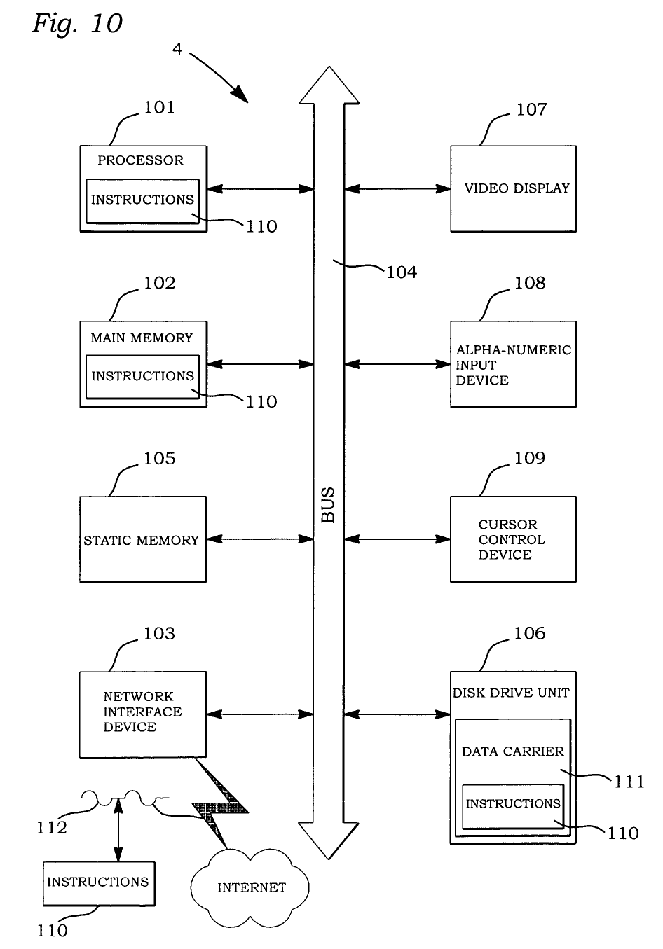

FIG. 10 is a diagrammatic representation of a computer system which provides the functionality of the mail server 4 of FIG. 1, and is therefore denoted as “mail server computer system 4”. Within the mail server computer system 4 a set of instructions, to cause the computer system to perform any of the methodologies discussed herein, may be executed. The mail server computer system 1 includes a processor 101, a main memory 102 and a network interface device 103, which communicate with each other via a bus 104. Optionally, it may further include a static memory 105 and a disk-drive unit 106. A video display 107, an alpha-numeric input device 108 and a cursor control device 109 may form a distribution list navigator user interface. The network interface device 103 connects the distribution list computer system 1 to the Internet. A set of instructions (i.e. software) 110 embodying any one, or all, of the methodologies described above, resides completely, or at least partially, in or on a machine-readable medium, e.g. the main memory 102 and/or the processor 101. A machine-readable medium on which the software 110 resides may also be a data carrier 111 (e.g. a non-removable magnetic hard disk or an optical or magnetic removable disk) which is part of disk drive unit 106. The software 110 may further be transmitted or received as a propagated signal 112 via the Internet through the network interface device 103.

Thus, the embodiments of the invention described above enable e-mail distribution lists to be generated and updated on the basis of an arrangement of persons in groups stored in a organizational database system.

All publications and existing systems mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims literally or under the doctrine of equivalents.

What is claimed is:

1. A method of automatically generating and updating e-mail distribution lists comprising e-mail addresses of persons of an organization using an arrangement of the persons in one or more groups according to an organizational relationship, the one or more groups being stored in an organizational database system, the method comprising:
generating an e-mail distribution list structure reflecting the arrangement of the persons in the one or more groups according to the organizational relationship by automatically merging the e-mail addresses of the persons of the one or more groups into corresponding e-mail distribution lists, and
updating the e-mail distribution lists consistently with an update of the organizational database system.

2. The method of claim 1, wherein the e-mail distribution lists are stored on a mail server, a user accesses the mail server via a web interface running on a client, and the organizational database system communicates with the mail server via a tree structure represented in a data exchange format.

3. The method of claim 2, wherein e-mail addresses defining the e-mail distribution lists are stored in a configuration file on the mail server, and the configuration file is divided into different sections storing a set of distribution lists for each criterion.

4. The method of claim 3, wherein one tree structure comprises information for defining the e-mail distribution lists of one criterion.

5. The method of claim 4, wherein updating the e-mail distribution lists comprises
generating at least one tree structure or parts thereof out of the data from the organizational database system,
transmitting the arrangement of the persons in groups or parts thereof to the mail server, and
updating the corresponding e-mail distribution lists in the configuration file.

6. The method of claim 1, wherein a graphical user interface displays the groups in a tree-like manner by means of icons, and offers possibilities to hide and re-display selected sub-structures of e-mail distribution lists.

7. The method of claim 1, wherein the number of recipients of the e-mail distribution lists is displayed.

8. The method of claim 5, wherein the e-mail distribution lists are updated on demand, in response to a selection of a criterion.

9. The method of claim 8, wherein, within the context of each update procedure, the tree structures of all criteria are newly generated out of the current data from the organizational database system, and are transmitted to the mail server.

10. The method of claim 8, wherein, within the context of each update procedure, the tree structure of the selected criterion is newly generated out of the current data from the organizational database system, and is transmitted to the mail server.

11. The method of claim 8, wherein the update is performed incrementally in such a way that changes in the organizational database system resulting in changes in the e-mail distribution lists are transmitted to the mail server in the form of parts of the tree structures of all criteria reflecting the changes.

12. The method of claim 8, wherein the update is performed incrementally in such a way that changes in the organizational database system resulting in changes in the e-mail distribution lists are transmitted to the mail server in the form of parts of the tree structure of the selected criterion reflecting the changes.

13. The method of claim 5, wherein the e-mail distribution lists are updated at regular intervals.

14. The method of claim 13, wherein, within the context of each update procedure, the tree structures of all criteria are newly generated out of the current data from the organizational database system, and are transmitted to the mail server.

15. The method of claim 13, wherein updating the e-mail distribution lists is performed incrementally in such a way that changes in the organizational database system resulting in changes in the e-mail distribution lists are transmitted to the mail server in the form of parts of the tree structures of all criteria reflecting the changes.

16. The method of claim 5, wherein the e-mail distribution lists are updated in response to a change in the organizational database system.

17. The method of claim 16, wherein, within the context of each update procedure, the tree structures of all criteria are newly generated out of the current data from the organizational database system, and are transmitted to the mail server.

18. The method of claim 16, wherein updating the distribution lists is performed incrementally in such a way that changes in the arrangement of persons in groups stored in the organizational database system resulting in changes in the distribution lists are transmitted to the mail server in the form of parts of the tree structures of all criteria reflecting the changes.

19. A computer system for automatically generating and updating e-mail distribution lists comprising e-mail addresses of persons of an organization using an arrangement of the persons in one or more groups according to an organizational relationship, the one or more groups being stored in an organizational database system, the computer system being programmed to:
generate an e-mail distribution list structure reflecting the arrangement of the persons in the one or more groups according to the organizational relationship by automatically merging the e-mail addresses of the persons of the one or more groups into corresponding e-mail distribution lists, and
update the e-mail distribution lists consistently with an update of the organizational database system.

20. A computer program product which is either in the form of a machine-readable medium with program code stored on it, or in the form of a propagated signal comprising a representation of program code,
wherein the program code is arranged to carry out a method, when executed on a computer system, of automatically generating and updating e-mail distribution lists comprising e-mail addresses of persons of an organization using an arrangement of the persons in one or more groups according to an organizational relationship, the one or more groups being stored in an organizational database system, the program code being programmed to:
generate an e-mail distribution list structure reflecting the arrangement of the persons in the one or more groups according to the organizational relationship by automatically merging the e-mail addresses of the persons of the one or more groups into corresponding e-mail distribution lists, and
update the e-mail distribution lists consistently with an update of the organizational database system.
